(19) United States
(12) Patent Application Publication
(10) Pub. No.: US 2011/0007680 A1
(43) Pub. Date: Jan. 13, 2011

(54) SLEEP MODE DESIGN FOR COEXISTENCE MANAGER

(75) Inventors: Tamer A. Kadous, San Diego, CA (US); Joel B. Linsky, San Diego, CA (US); Ashok Mantravadi, San Diego, CA (US); Hans Georg Gruber, San Deigo, CA (US)

Correspondence Address: QUALCOMM INCORPORATED, 5775 MOREHOUSE DR., SAN DIEGO, CA, 92121, US

(73) Assignee: QUALCOMM incorporated, San Diego, CA (US)

(21) Appl. No.: 12/616,074

(22) Filed: Nov. 10, 2009

Related U.S. Application Data
(60) Provisional application No. 61/224,324, filed on Jul. 9, 2009.
(60) Provisional application No. 61/244,257, filed on Sep. 21, 2009.

(51) Int. Cl. G08C 17/02; H04B 7/005

(52) U.S. Cl. 370/311; 455/517

(57) ABSTRACT

Systems and methodologies are described herein that facilitate implementation and use of a sleep mode for a multi-radio coexistence manager. As described herein, respective radios coordinated by a coexistence manager (CxM) can be grouped into radio or sleep clusters, for which the CxM can enter a low-power mode (e.g., a sleep mode) based on respective operating states of radios in the clusters. As further described herein, a CxM can provide an acquisition sequence and/or other suitable means to enable respective radios to synchronize with the CxM. In addition, techniques are provided herein by which a CxM can indicate its present operating mode (e.g., active, wakeable sleep, non-wakeable sleep, or disabled) to respective radios, and by which a radio can wake the CxM from a sleep operating mode under predetermined circumstances.

### CROSS-REFERENCE

This application claims the benefit of U.S. Provisional Application Ser. No. 61/224,324, filed Jul. 9, 2009, and entitled “SLEEP MODE DESIGN FOR COEXISTENCE MANAGER,” and 61/244,257, filed Sep. 21, 2009, and entitled “SLEEP MODE DESIGN FOR COEXISTENCE MANAGER,” the entirety of which is incorporated herein by reference.

### BACKGROUND

I. Field

The present disclosure relates generally to wireless communications, and more specifically to managing coexistence between multiple radios utilized by respective devices in a wireless communication system.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and Single-Carrier FDMA (SC-FDMA) systems.

Generally, a wireless multiple-access communication system can include a number of radios to support communication with different wireless communication systems. Respective radios can operate on certain frequency channels or bands or can have respective predefined requirements. In order to manage communication via multiple radios and avoid collisions and/or interference between respective radios, a coexistence manager (CxM) and/or other means can be utilized to arbitrate between respective radios that are in collision (e.g., radios configured such that their mutual operation would cause significant interference on at least one of the radios). Thus, it would be desirable to implement techniques by which a CxM and/or another entity operable to accomplish at least the foregoing ends can operate in a substantially power-efficient manner.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method is described herein. The method can comprise identifying one or more radios operating within at least one cluster; determining operating states of respective identified radios from among an active state, a sleep state, and a disabled state; and selecting a coexistence manager (CxM) operating mode based at least in part on determined operating states of the respective identified radios.

A second aspect described herein relates to a wireless communications apparatus, which can comprise a memory that stores data relating to one or more radios and at least one radio cluster in which the one or more radios operate. The wireless communications apparatus can further comprise a processor configured to determine operating states of the one or more radios from among an active state, a sleep state, and a disabled state, and to select a CxM operating mode based at least in part on determined operating states of the one or more radios.

A third aspect relates to an apparatus, which can comprise means for identifying one or more sleep clusters that respectively include at least one radio; means for identifying operating states of respective radios included in the one or more sleep clusters; and means for selecting a CxM operating mode with respect to the one or more sleep clusters based on the operating states of the respective radios included in the one or more sleep clusters.

A fourth aspect described herein relates to a computer program product, which can include a computer-readable medium that comprises code for causing a computer to identify one or more radios and at least one radio cluster in which the one or more radios operate; code for causing a computer to determine operating states of the one or more radios from among an active state, a sleep state, and a disabled state; and code for causing a computer to select a CxM operating mode based at least in part on determined operating states of the one or more radios.

A fifth aspect described herein relates to an integrated circuit operable to execute a set of machine-executable instructions. The set of machine-executable instructions can comprise identifying one or more sleep clusters that respectively include at least one radio; identifying operating states of respective radios included in the one or more sleep clusters; and selecting a CxM operating mode with respect to the one or more sleep clusters based on the operating states of the respective radios included in the one or more sleep clusters.

According to a sixth aspect, a method is described herein. The method can comprise observing one or more bus lines associated with a CxM and identifying an operating state of the CxM based at least in part on the observing.

A seventh aspect described herein relates to a wireless communications apparatus, which can comprise a memory that stores data relating to a CxM and a bus associated with the CxM comprising at least one bus line. The wireless communications apparatus can further comprise a processor configured to determine an operating mode utilized by the CxM at least in part by monitoring the bus associated with the CxM.

An eighth aspect relates to an apparatus, which can comprise means for monitoring values conveyed on one or more bus lines associated with a CxM and means for determining an operating mode of the CxM based on values observed during monitoring of the one or more bus lines

A ninth aspect described herein relates to a computer program product, which can include a computer-readable medium that comprises code for causing a computer to identify a CxM; code for causing a computer to identify a bus associated with the CxM; and code for causing a computer to determine an operating mode utilized by the CxM at least in part by monitoring the bus associated with the CxM.

A tenth aspect described herein relates to an integrated circuit operable to execute a set of machine-executable instructions. The set of machine-executable instructions can comprise monitoring values conveyed on one or more bus lines associated with a CxM and determining an operating mode of the CxM based on values observed during monitoring of the one or more bus lines

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is a block diagram of an example wireless communication environment in which various aspects described herein can function.

FIG. 2 is a block diagram of an example wireless device that can be operable to manage coexistence between respective radios in an associated wireless communication system in accordance with various aspects.

FIG. 3 illustrates an example set of radios that can be implemented in a wireless communication environment and respective potential collisions that can occur among the example set of radios.

FIG. 4 is a block diagram of a system for enabling and utilizing a radio coexistence manager sleep mode in accordance with various aspects.

FIG. 5 illustrates an example bus structure that can be utilized to support coexistence manager sleep in accordance with various aspects.

FIG. 6 illustrates example scenarios based on which a coexistence manager can select an operating mode in accordance with various aspects.

FIG. 7 is a state diagram that illustrates an example coexistence manager operating mode selection procedure.

FIG. 8 is a block diagram of a system for acquiring a coexistence manager state and operating according to the acquired coexistence manager state in accordance with various aspects.

FIG. 9 is a state diagram that illustrates example radio operation in the context of a coexistence manager sleep mode in accordance with various aspects.

FIGS. 10-11 are flow diagrams of respective methodologies for supporting sleep mode operation of a radio coexistence manager associated with a multi-radio wireless device.

FIG. 12 is a flow diagram of a methodology for ascertaining an operating state of an associated radio coexistence manager.

FIGS. 13-14 are block diagrams of respective apparatuses that facilitate usage of a sleep operating mode for a multi-radio coexistence manager.

FIG. 15 is a block diagram of a wireless communications device that can be utilized to implement various aspects described herein.

FIGS. 16-17 are block diagrams that illustrate respective aspects of an example coexistence manager that can be utilized to implement various aspects described herein.

FIG. 18 illustrates operation of an example coexistence manager in time.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, it can be appreciated that various illustrative logical blocks, modules, circuits, algorithm steps, etc., described in connection with the disclosure herein can be implemented as electronic hardware, computer software, or combinations of both. To clearly illustrate this interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the disclosure herein can additionally or alternatively be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, or alternatively the processor can be any conventional processor, controller, microcontroller, state machine, or the like. A processor can also be implemented as a combination of computing devices, e.g., a combination of a DSP and a microprocessor, a plurality of microprocessors, one or more microprocessors in conjunction with a DSP core, or any other such configuration.

Furthermore, various functions of one or more example embodiments described herein can be implemented in hardware, software, firmware, or any combination thereof. If implemented in software, the functions can be stored on or transmitted as one or more instructions or code on a computer-readable medium. Computer-readable media can include both computer storage media and communication media. Communication media can include any medium that facilitates transfer of a computer program from one place to another. Likewise, storage media can include any available media that can be accessed by a general purpose or special purpose computer. By way of example, and not limitation, computer-readable media can comprise RAM, ROM, EEPROM, CD-ROM, digital versatile disc (DVD), blu-ray disc, or other optical disk storage, magnetic disk storage or other magnetic storage devices, and/or any other medium that can be used to carry or store desired program code means in the form of instructions or data structures and that can be accessed by a general-purpose or special-purpose computer or a general-purpose or special-purpose processor. Further, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and/or microwave, then such means are intended to be included in the definition of medium. “Disk” and “disc,” as used herein, includes compact disc (CD), laser disc, optical disc, DVD, floppy disk, and blu-ray disc, where “disks” generally reproduce data magnetically while “discs” reproduce data optically (e.g., with lasers). Combinations of the above can also be included within the scope of computer-readable media.

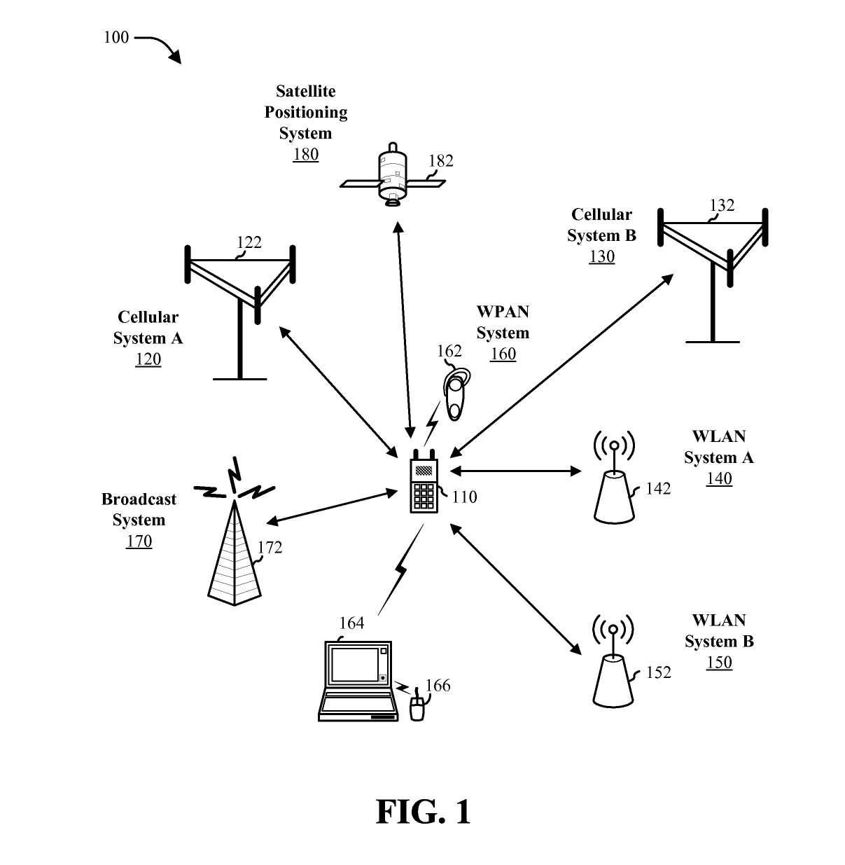

Referring now to the drawings, FIG. 1 illustrates an example wireless communication environment 100 in which various aspects described herein can function. Wireless communication environment 100 can include a wireless device 110, which can be capable of communicating with multiple communication systems. These systems can include, for example, one or more cellular systems 120 and/or 130, one or more wireless local area network (WLAN) systems 140 and/or 150, one or more wireless personal area network (WPAN) systems 160, one or more broadcast systems 170, one or more satellite positioning systems 180, other systems not shown in FIG. 1, or any combination thereof It should be appreciated that in the following description the terms “network” and “system” are often used interchangeably.

Cellular systems 120 and 130 can each be a CDMA, TDMA, FDMA, OFDMA, SC-FDMA, or other suitable system. A CDMA system can implement a radio technology such as Universal Terrestrial Radio Access (UTRA), cdma2000, etc. UTRA includes Wideband CDMA (WCDMA) and other variants of CDMA. Moreover, cdma2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). In an aspect, cellular system 120 can include a number of base stations 122, which can support bi-directional communication for wireless devices within their coverage. Similarly, cellular system 130 can include a number of base stations 132 that can support bi-directional communication for wireless devices within their coverage.

WLAN systems 140 and 150 can respectively implement radio technologies such as IEEE 802.11 (Wi-Fi), Hiperlan, etc. WLAN system 140 can include one or more access points 142 that can support bi-directional communication. Similarly, WLAN system 150 can include one or more access points 152 that can support bi-directional communication. WPAN system 160 can implement a radio technology such as Bluetooth, IEEE 802.15, etc. Further, WPAN system 160 can support bi-directional communication for various devices such as wireless device 110, a headset 162, a computer 164, a mouse 166, or the like.

Broadcast system 170 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, broadcast system 170 can include one or more broadcast stations 172 that can support one-way communication.

Satellite positioning system 180 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, satellite positioning system 180 can include a number of satellites 182 that transmit signals used for position determination.

In an aspect, wireless device 110 can be stationary or mobile and can also be referred to as a user equipment (UE), a mobile station, a mobile equipment, a terminal, an access terminal, a subscriber unit, a station, etc. Wireless device 110 can be a cellular phone, a personal digital assistant (PDA), a wireless modem, a handheld device, a laptop computer, a cordless phone, a wireless local loop (WLL) station, etc. In addition, wireless device 110 can engage in two-way communication with cellular system 120 and/or 130, WLAN system 140 and/or 150, devices within WPAN system 160, and/or any other suitable system(s) and/or device(s). Wireless device 110 can additionally or alternatively receive signals from broadcast system 170 and/or satellite positioning system 180. In general, it can be appreciated that wireless device 110 can communicate with any number of systems at any given moment.

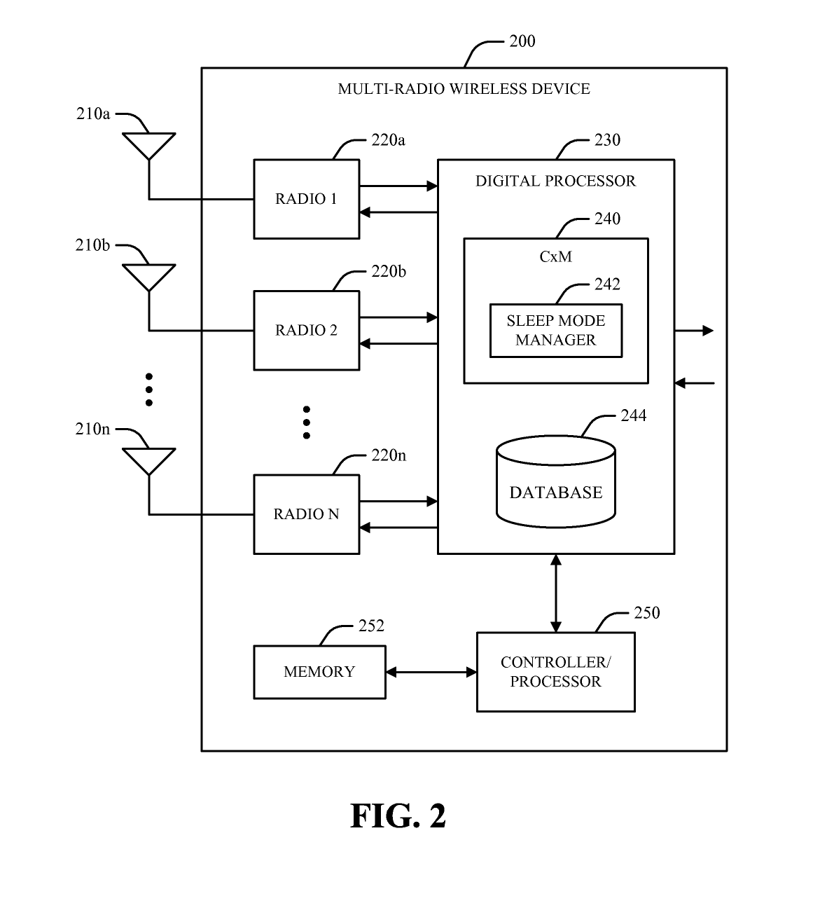

Turning next to FIG. 2, a block diagram is provided that illustrates an example design for a multi-radio wireless device 200. As FIG. 2 illustrates, wireless device 200 can include N radios 220a through 220n, which can be coupled to N antennas 210a through 210n, respectively, where N can be any integer value. It should be appreciated, however, that respective radios 220 can be coupled to any number of antennas 210 and that multiple radios 220 can also share a given antenna 210.

In general, a radio 220 can be a unit that radiates or emits energy in an electromagnetic spectrum, receives energy in an electromagnetic spectrum, or generates energy that propagates via conductive means. By way of example, a radio 220 can be a unit that transmits a signal to a system or a device or a unit that receives signals from a system or device. Accordingly, it can be appreciated that a radio 220 can be utilized to support wireless communication. In another example, a radio 220 can also be a unit (e.g., a screen on a computer, a circuit board, etc.) that emits noise, which can impact the performance of other radios. Accordingly, it can be further appreciated that a radio 220 can also be a unit that emits noise and interference without supporting wireless communication.

In accordance with one aspect, respective radios 220 can support communication with one or more systems. Multiple radios 220 can additionally or alternatively be used for a given system, e.g., to transmit or receive on different frequency bands (e.g., cellular and PCS bands).

In accordance with another aspect, a digital processor 230 can be coupled to radios 220a through 220n and can perform various functions, such as processing for data being transmitted or received via radios 220. The processing for each radio 220 can be dependent on the radio technology supported by that radio and can include encryption, encoding, modulation, etc., for a transmitter; demodulation, decoding, decryption, etc., for a receiver, or the like. In one example, digital processor 230 can include a coexistence manager (CxM) 240 that can control the operation of radios 220 in order to improve the performance of wireless device 200 as generally described herein. CxM 240 can have access to a database 244, which can store information used to control the operation of radios 220.

For simplicity, digital processor 230 is shown in FIG. 2 as a single processor. However, it should be appreciated that digital processor 230 can comprise any number of processors, controllers, memories, etc. In one example, a controller/processor 250 can direct the operation of various units within wireless device 200. Additionally or alternatively, a memory 252 can be used to store program codes and data for wireless device 200. Digital processor 230, controller/processor 250, and memory 252 can be implemented on one or more integrated circuits (ICs), application specific integrated circuits (ASICs), etc. By way of specific, non-limiting example, digital processor 230 can be implemented on a Mobile Station Modem (MSM) ASIC.

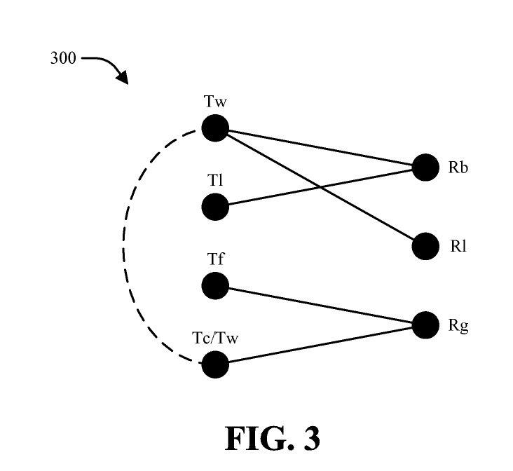

In accordance with one aspect, CxM 240 can be utilized to manage operation of respective radios 220 utilized by wireless device 200 in order to avoid interference and/or other performance degradation associated with collisions between respective radios 220. By way of further illustration, graph 300 in FIG. 3 represents respective potential collisions between seven example radios in a given decision period. In the example shown in graph 300, the seven radios include a WLAN transmitter (Tw), an LTE transmitter (T1), an FM transmitter (Tf), a GSM/WCDMA transmitter (Tc), an LTE receiver (R1), a Bluetooth receiver (Rb), and a GPS receiver (Rg). The four transmitters are represented by four nodes on the left side of graph 300, and the three receivers are represented by three nodes on the right side of graph 300. A potential collision between a transmitter and a receiver is represented on graph 300 by a branch connecting the node for the transmitter and the node for the receiver. Accordingly, in the example shown in graph 300, collisions may exist between (1) a WLAN transmitter (Tw) and a Bluetooth receiver (Rb); (2) a LTE transmitter (T1) and a Bluetooth receiver (Rb); (3) a WLAN transmitter (Tw) and a LTE receiver (R1); (4) a FM transmitter (Tf) and a GPS receiver (Rg); and (5) a WLAN transmitter (Tw), a GSM/WCDMA transmitter (Tc), and a GPS receiver (Rg).

As noted above, CxM 240 can function to arbitrate between respective radios 220 that are in collision (e.g., radios configured such that their mutual operation causes substantial interference on at least one of them). However, it can be appreciated that performing arbitration for respective radios 220 can be substantially complex in some cases, requiring substantial amounts of power consumption and/or other operational costs. Accordingly, in one example, CxM 240 can utilize a sleep mode manager 242 to enable CxM 240 to sleep (e.g., by entering a sleep operating mode and/or another suitable low-power operating mode) under various conditions. Thus, it can be appreciated that CxM 240 can be associated with various sleep designs that allow CxM 240 to manage radios 220 in sleep mode and/or that place CxM 240 in sleep when possible. As a result, it can be appreciated that sleep mode manager 242 can lower the overall power consumption of CxM 240 by smartly turning off CxM 240 when possible.

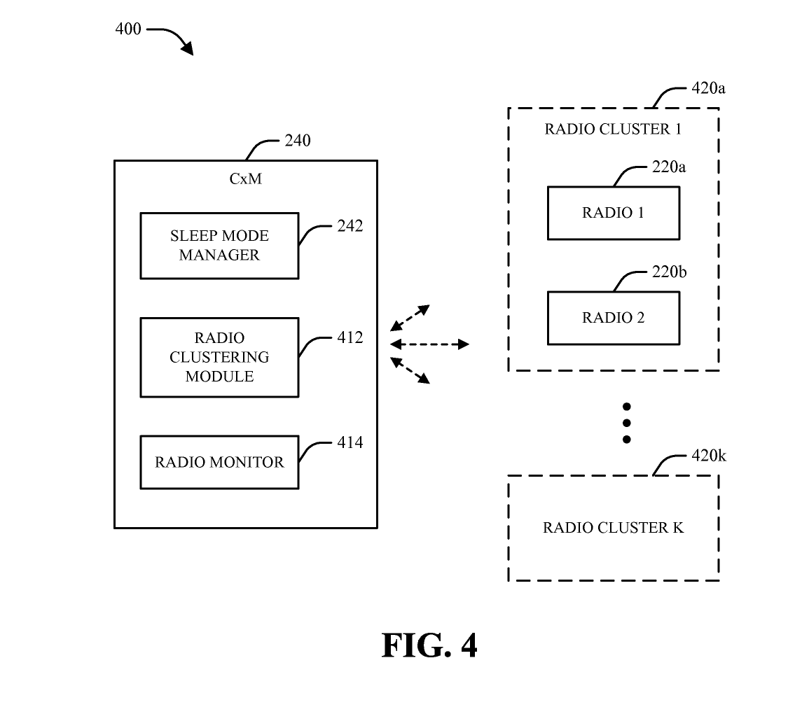

Referring next to FIG. 4, a block diagram of a system 400 is illustrated that provides further detail regarding the operation of CxM 240 and sleep mode manager 242. In accordance with one aspect, system 400 can include a CxM 240, which can be utilized to monitor respective radios 220 (e.g., using a radio monitor 414) and to arbitrate between one or more radios 220 in collision. In one example, a radio clustering module 412 can be utilized by CxM 240 to group respective radios 220 that can potentially collide into respective radio clusters 420. Accordingly, sleep mode manager 242 can enable CxM 240 to handle radios 220 corresponding to one or more radio clusters 420 in sleep mode when possible, thereby reducing the power consumption of CxM 240.

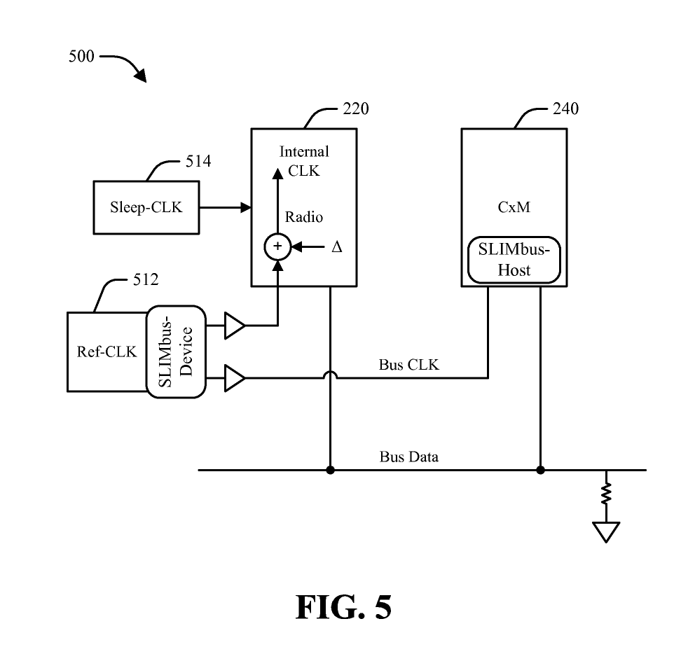

In accordance with one aspect, an example structure that can be utilized by CxM 240 and/or radio(s) 220 to facilitate a sleep mode design for CxM 240 is illustrated by diagram 500 in FIG. 5. As FIG. 5 illustrates, a reference clock (Ref-CLK) 512 can be provided such that respective radios 220 have access to the reference clock 512 when active. As diagram 500 further illustrates, respective radios 220 can additionally or alternatively be associated with an internal clock (CLK), which can be derived from the reference clock 512 and/or any other suitable mechanism(s). Additionally or alternatively, a separate sleep clock 514 can be provided and utilized by respective radios 220.

As additionally shown in diagram 500, respective radios 220 can be connected to an associated CxM 240 by means of a two-wire, multi-drop bus (e.g., having a CLK line and a data line) and/or any other suitable means. Accordingly, sleep mode management of respective radios 220 and/or CxM 240 can be controlled by manipulating one or more bus lines (e.g., a clock line and/or a data line associated with the bus) connecting the respective radios 220 and CxM 240. Examples of setting respective bus lines in this manner are provided in further detail herein.

In accordance with one aspect, the power domain of CxM 240 can be independent from that of any radio 220 such that, for example, power to CxM 240 is turned off when CxM 240 is put to sleep. In another example, CxM 240 can operate in an always-on island. In accordance with another aspect, a host associated with the elements represented in diagram 500 can have data ports in an amount proportional to the number of connected radios 200, which can be broadcast-sized as a function of the number of broadcast ports. Additionally or alternatively, respective radios 220 can have one dedicated port and a broadcast-bitsize dependent number of broadcast ports (e.g., 4 broadcast ports).

Returning to FIG. 4, respective radios 220 can in one example be organized into radio clusters (or “sleep clusters”) 420 (e.g., by a radio clustering module 412), which can be defined as maximally connected components in the graph formed by all radios on a given device without time division duplexing restrictions. In accordance with one aspect, respective radios 220 can operate in an active, sleep, or disabled state. For example, a radio 220 can operate in an active state when enabled and either on a sleep cycle but awake or coming out of a disabled state (e.g., when enabled into an active state).

Additionally or alternatively, CxM 240 can operate in an active, sleep, or disabled state. In one example, CxM 240 can operate in an active state if two or more radios 220 are active in a sleep cluster 420 or some radios 220 in a sleep cluster 420 are active and some are on a sleep cycle (e.g., at least a first radio in a cluster is active and at least a second, disparate radio is active or on a sleep cycle). Alternatively, CxM 240 can operate in a sleep state if CxM 240 is not active and at least one non-disabled radio 220 is present in system 400.

In accordance with one aspect, a CxM sleep state can be split into respective sub-states per sleep cluster 420, which can be expressed as a vector of states (e.g., one per sleep cluster 420) and/or by any other suitable means. For example, a non-wakeable sleep sub-state can be defined and utilized by CxM 240 if CxM 240 is in sleep and at most one radio 220 is enabled for a given sleep cluster 420. In one example, while CxM 240 is in non-wakeable sleep for a given sleep cluster 420, enabled radios 240 in the sleep cluster 220 can be configured such that they cannot wake up CxM 240. Additionally or alternatively, respective radios 220 in the sleep cluster 420 can be configured to wake up CxM 240 upon moving from a disabled state to an enabled state even if CxM 240 is in non-wakeable sleep. As another example, a wakeable sleep sub-state can be defined and utilized by CxM 240 for a given sleep cluster 420 if CxM 240 is in sleep, two or more radios 220 in the sleep cluster 420 are enabled (e.g., not disabled), and substantially all non-disabled radios 220 in the sleep cluster 420 are in sleep. By utilizing different sub-states in this manner, it can be appreciated that radios 220 can be enabled to work independently if their counterparts are disabled.

By way of non-limiting example, a sleep mode manager 242 at CxM 240 can control the operating mode of CxM 240 as follows. First, if all radios 220 associated with CxM 240 are disabled, CxM 240 can be placed in an inactive (e.g., disabled) or sleep mode (e.g., non-wakeable sleep). Alternatively, if one radio 220 per radio cluster 420 is active or operating on a sleep cycle, CxM 240 can be placed in a sleep mode (e.g., a non-wakeable sleep sub-state).

As another alternative, if two or more radios 220 per radio cluster 420 are active, or at least two radios 220 per radio cluster 420 are not disabled such that at least one radio 220 is active and at least another radio 220 is active or on a sleep cycle, CxM 240 can be placed in an active state. Otherwise, it can be appreciated that CxM 240 may in some cases lack sufficient information relating to active radio events in the event that a colliding radio 220 wakes up and wakes up CxM 240.

As a further alternative, if CxM 240 is in sleep, at least two radios 220 in a radio cluster 420 are not disabled, and substantially all non-disabled radios 220 in the radio cluster 420 are on sleep cycles, CxM 240 can be placed in a wakeable sleep sub-state. It can be appreciated that this is a desirable alternative to disabling CxM 240 in such a scenario, as the possibility can exist of multiple radios 220 waking up from respective sleep cycles at the same time and colliding.

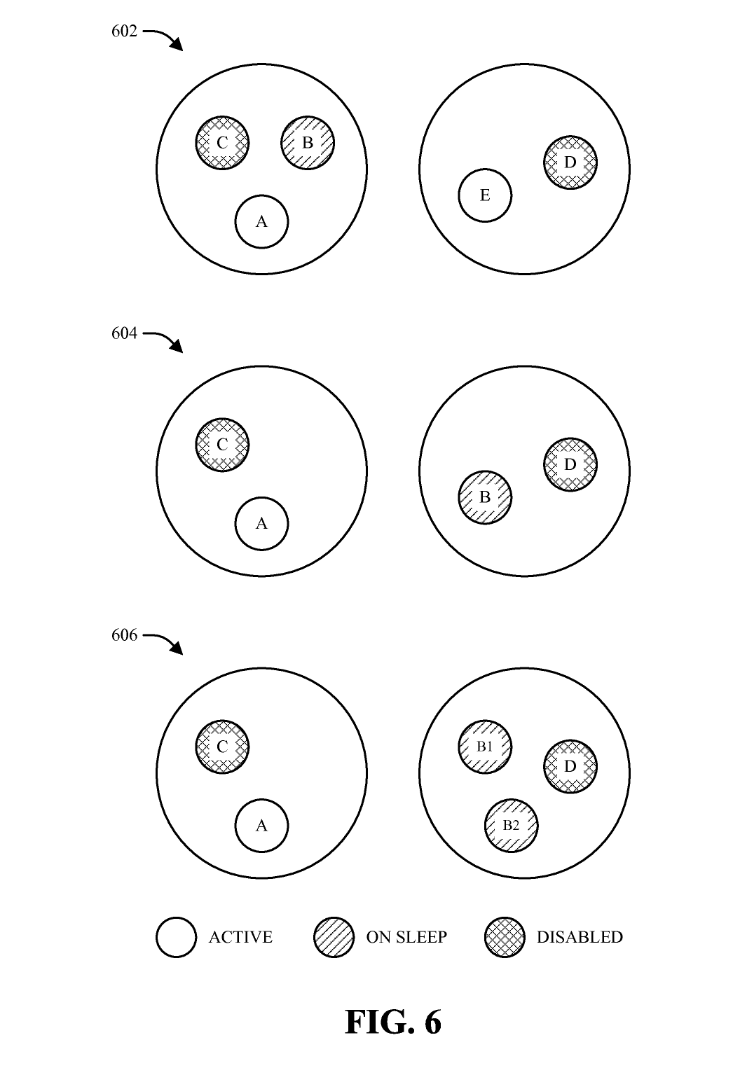

Various examples of the above operating mode selection procedures for CxM 240 are illustrated in further detail by diagrams 602-606 in FIG. 6. More particularly, smaller circles in diagrams 602-606 represent radios, while the larger circles encompassing the smaller circles represent radio sleep clusters.

In the first example shown in diagram 602, radio A is active and radio B is in a sleep cycle in the leftmost cluster. Accordingly, an associated CxM can be placed in an active state. In the second example shown in diagram 604, a single radio (radio A) is active in the leftmost cluster and a single radio (radio B) is in a sleep cycle in the rightmost cluster. Accordingly, an associated CxM can be placed in sleep mode and a non-wakeable state for both clusters. In the third example shown in diagram 606, one active radio (radio A) is present in the leftmost cluster and two radios in sleep cycles (radios B1 and B2) are present in the rightmost cluster. Accordingly, CxM can be placed in sleep mode and made non-wakeable for the leftmost cluster and wakeable for the rightmost cluster.

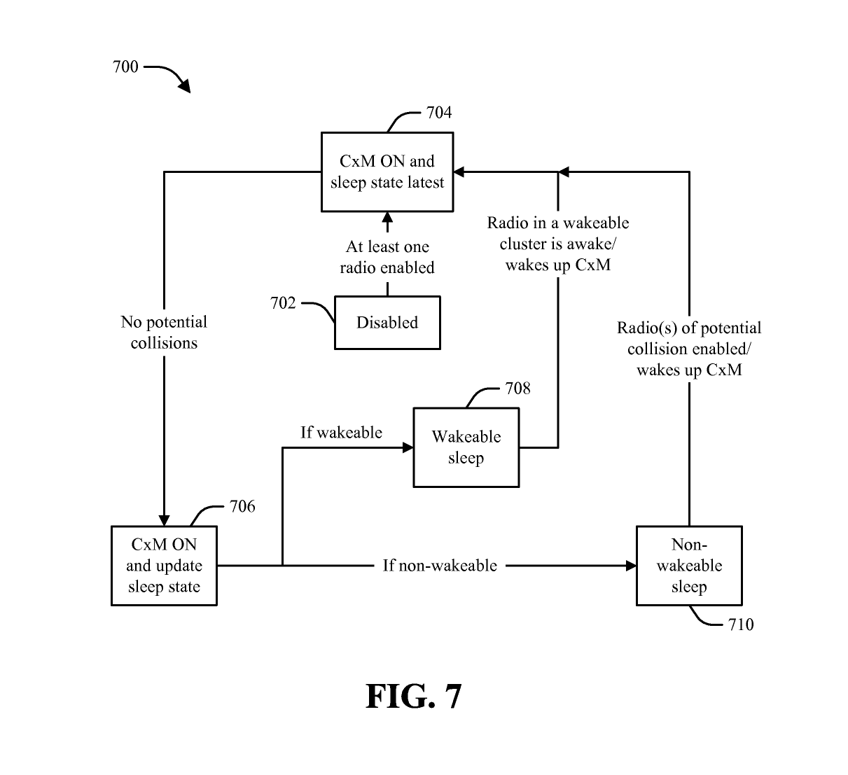

Referring next to FIG. 7, a state diagram 700 is provided that illustrates example techniques by which a CxM can transition between operating states or modes. As diagram 700 illustrates, a CxM starting in a disabled state as illustrated at block 702 can enter an active or ON state as illustrated at block 704 upon at least one associated radio becoming enabled. Once active, in the event that the CxM determines that there are no potential collisions, the CxM can update its sleep sub-state (e.g., wakeable or non-wakeable) to respective associated radios as shown at block 706 by applying one or more sleep state decision rules as generally described herein (e.g., as illustrated by FIG. 6 above) to the respective radios. In one example, the CxM can wait for the associated radios to wake up prior to performing further action at the state illustrated at block 706 in order to ensure that the radios receive the updated sleep state.

With respect to radios for which wakeable sleep is utilized and indicated, the CxM can enter wakeable sleep as shown at block 708. Subsequently, upon a radio in a wakeable cluster waking up, the radio can wake up the CxM such that the CxM re-enters an active or ON state as illustrated at block 704. Alternatively, for radios for which non-wakeable sleep is utilized and indicated, the CxM can enter non-wakeable sleep as shown at block 710. Upon entering non-wakeable sleep, the CxM can again activate as illustrated at block 704 if a radio associated with a potential collision (e.g., in a non-wakeable cluster) is activated and wakes up the CxM.

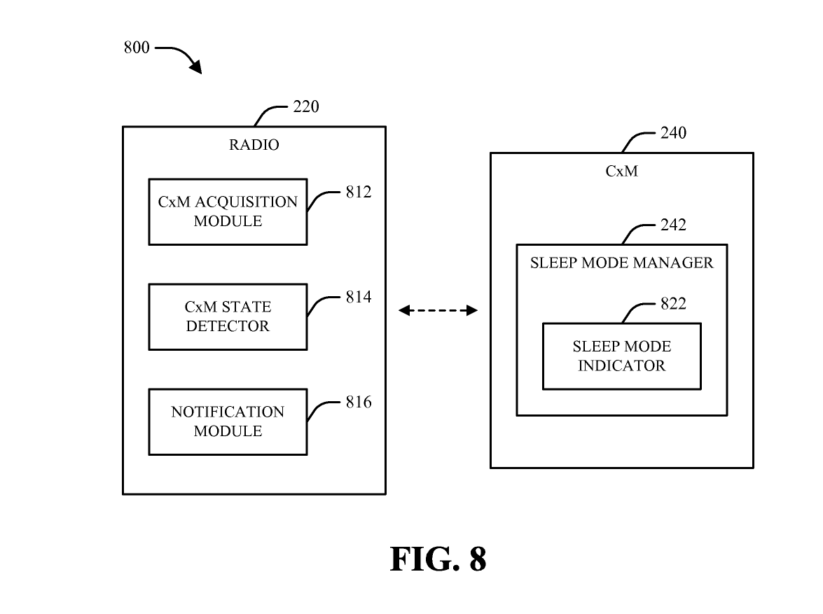

Turning to FIG. 8, a block diagram of a system 800 for acquiring a CxM state and operating according to the acquired CxM in accordance with various aspects is illustrated. System 800 can include one or more radios 220, which can operate in the context of respective radio clusters (e.g., radio clusters 420, not shown). Further, respective radios 220 in system 800 can be associated with a CxM 240, which can manage respective radios 220 to avoid collisions between the radios 220 as generally described herein.

In accordance with one aspect, in the event that CxM 240 is enabled, a CxM acquisition module 812 and/or another suitable mechanism associated with radio 220 can be utilized by radio 220 upon moving to an active state to associate with CxM 240. In another example, if CxM 240 is on sleep, radio 220 can utilize a CxM state detector 814 and/or other suitable means upon moving from sleep to an active state in order to follow the latest CxM sub-state. In a further example, a notification module 816 and/or other suitable mechanism(s) associated with radio 220 can be utilized by radio 220 to wake up CxM 240 at the time radio 220 is enabled if CxM is determined not to already be awake. In accordance with an additional aspect, a sleep mode manager 242 and/or other suitable mechanisms utilized by CxM 240 can leverage a sleep mode indicator 822, which can be utilized by CxM 240 to ensure that radios 220 have the latest sleep sub-state of CxM 240. Accordingly, a decision unit (DU) timeline associated with CxM 240 can be made relative in the sense that the timeline depends on the wakeup time of CxM 240.

In accordance with a further aspect, CxM acquisition module 812 can be utilized in various manners by radio 220 such that radio 220 can synchronize with CxM 240 upon waking from sleep, at power-up, and/or at any other suitable time(s). For example, CxM 240 can broadcast a pseudorandom number (PN) sequence for acquisition (ACQ) during its processing time if active. By way of specific, non-limiting example, this sequence can be implemented for a set of 64-bit radio access channels starting with a header of 00 and ending with a trailer of 11 by adding an additional 64-bit broadcast ACQ channel. Using this ACQ channel, a 64-bit sequence (e.g., 10101 . . . ) can be broadcasted, such that radios 220 attempting to acquire CxM 240 can monitor each 64 consecutive bits on a bus associated with the channel. Subsequently, when the ACQ pattern is found, the radio 220 can utilize the pattern to determine the beginning of the response portion (e.g., synchronized to the DU timeline).

Additionally or alternatively, upon waking up from a sleep state, radio 220 can leverage CxM state detector 814 in various manners to determine whether CxM 240 is asleep or awake. For example, CxM 240 can utilize sleep mode indicator 822 and/or other suitable means to set its Active/Sleep state for respective radios 220 using registers associated with the radios 220 upon changes to its sleep state. This can, for example, be done under the assumption that a sleeping radio is able to read the state upon waking. Sleep mode indicator 822 can indicate the sleep state of CxM 240 by, for example, using registers on a power management integrated circuit (PMIC) and later waking up CxM 240 if needed, by utilizing an always-ON register, and/or by any other suitable means. For example, sleep mode indicator 822 at CxM 240 can maintain a set of registers that are on an always-on power domain in an associated PMIC, based on which CxM 240 can be configured to re-enter an active operating mode from a sleep operating mode upon receiving a wake-up command from the PMIC. A wake-up command provided by the PMIC can be, for example, provided in response to a radio 220 (e.g., a sleeping radio) interrupting and/or waking up the PMIC. More particularly, a wake-up command (e.g., in the form of an interrupt) can be provided to the PMIC from a sleeping radio upon waking from an associated sleep cycle. Upon receiving the wake-up command, the PMIC can check a radio sleep sub-state register corresponding to the radio to determine whether or not to wake up the CxM based on the wake-up command.

In an alternative example, sleep mode indicator 822 can pull one or more bus lines low (e.g., a clock line or a data line) upon CxM 240 entering sleep as an indication to radio 220. This can be done, for example, under the assumption that a time window slightly larger than that corresponding to one DU minus the length of a PN sequence is a sufficient window for radio 220 to determine whether CxM 240 is in sleep, such that when radio 220 becomes active it can monitor the relevant bus line(s) for a predefined window to identify the Active/Sleep state of CxM 240.

In accordance with another aspect, notification module 816 and/or other suitable mechanism(s) can be utilized by a radio 220 to wake up CxM 240 upon waking up and finding CxM 240 in wakeable sleep. For example, if a host for radio 220 is fully or partially awake, the host can serve as notification module 816 and/or otherwise be utilized to wake up CxM 240. Similarly, an always-ON domain on an associated PMIC can be utilized by notification module 816 to wake up CxM 240. In another example, as CxM 240 can indicate a sleep mode by pulling one or more bus lines low, notification module 816 at radio 220 can pull the affected bus lines high for a predefined period of time (e.g., a 32 KHz clock cycle) to wake up CxM 240 (e.g., if the bus line(s) are wired-OR).

In accordance with still another aspect, sleep mode indicator 822 and/or other suitable mechanisms can be utilized by CxM 240 in order for CxM 240 to ensure that all radios 220 have the latest sleep sub-state of CxM 240 before entering sleep mode. For example, sleep mode indicator 822 can set the sleep sub-state of CxM 240 for respective radios 220 prior to entering sleep mode in a similar manner to that described above for indicating Active/Sleep state. This example can be utilized under the assumption that a sleeping radio 220 is able to read the sleep sub-state of CxM 240 upon waking up. Alternatively, sleep mode indicator 822 can cause CxM 240 to abstain from entering sleep until each radio 220 that requires information relating to the CxM sub-state is awake (e.g., in connection with their respective sleep cycles) and receives the sleep sub-state.

By way of specific, non-limiting example, the SLIMbus Protocol can be utilized to support various operating modes (e.g., pause mode), which can in turn support an in-band mechanism for CxM sleep mode. For instance, if CxM 240 is ON and a radio 220 goes to sleep on its own after notification to the SLIMbus host (e.g., CxM 240), the radio 220 can synchronize to the bus without requiring ACQ pattern broadcasting upon waking.

In another example, a pause mode supported by SLIMbus can be utilized as a full power collapse when CxM 240 is put to sleep. More particularly, a pause mode supported by SLIMbus can be utilized as follows for CxM sleep mode control. After a SLIMbus-specific timing (e.g., a Superframe boundary), the clock and data lines of an associated SLIMbus-supported bus can be pulled high within the next two ticks of the following Superframe when the bus is in pause. In one example, this can be done without enabling transmission of a Frame Sync Symbol or toggling the data line. Accordingly, this can serve as an indication for any radio 220 that the bus is in sleep without requiring a separate mechanism. In another aspect, to wake up the bus, a radio 220 can toggle one or more bus lines (e.g., in a similar manner to the mechanism for waking up CxM 240).

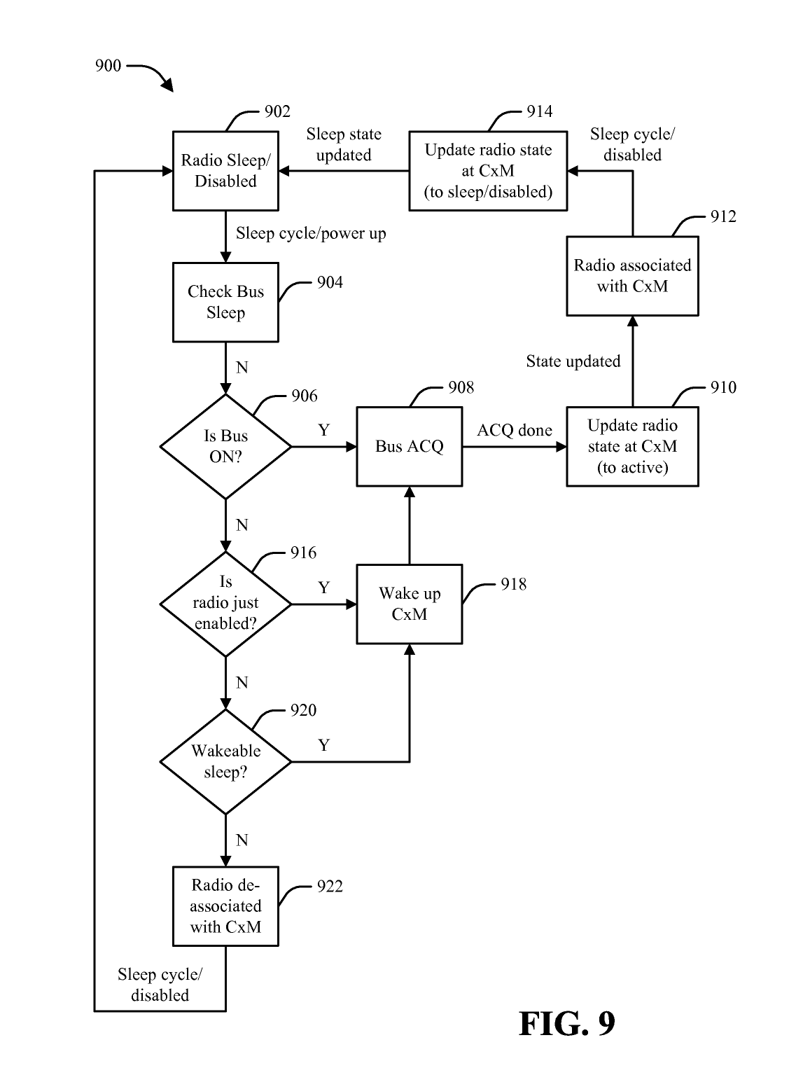

With reference next to FIG. 9, a state diagram 900 is provided that illustrates example operation of a radio with respect to a CxM. As diagram 900 illustrates, when a radio becomes active from a sleep cycle or a disabled state (e.g., as illustrated at block 902), the radio can check an associated bus as shown at block 904 to determine whether the bus is indicates a CxM sleep state. This can be accomplished by first determining whether the bus is on, as shown at block 906. If the bus is on, the radio can acquire the bus as shown at block 908, update the state of the radio at the CxM as shown at block 910, and associate with the CxM as shown at block 912. Alternatively, if the radio determines that the bus is not on, the radio can determine whether it has just become enabled, as illustrated at block 916. If so, the radio can wake up the CxM as shown at block 918 and subsequently perform bus acquisition and state updating as described above. If the radio has not just become enabled, the radio can subsequently determine whether the CxM is in a wakeable sleep sub-state, as illustrated by block 920. This can be accomplished by, for example, checking for a standard indication provided by the CxM (e.g., via a clock or data bus line). In the event that the CxM is in wakeable sleep and/or it is otherwise determined that the CxM should be awaken, the radio can wake up the CxM as shown at block 918 and subsequently perform bus acquisition and state updating as described above. Otherwise, the radio can de-associate with the CxM as shown at block 922. As further shown in diagram 900, upon disabling or returning to sleep, the radio can update its state with the CxM as necessary prior to returning to the desired state, as illustrated by block 914.

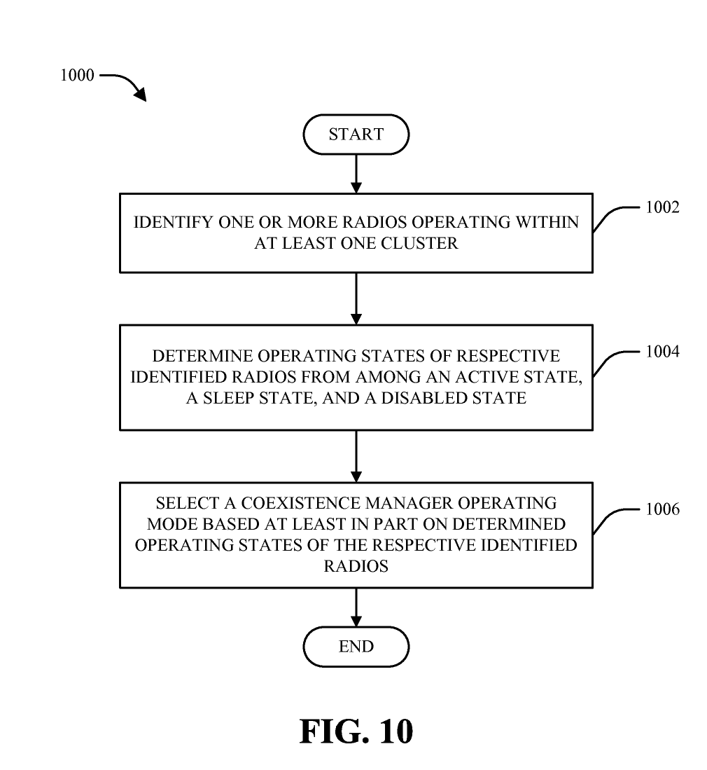

Referring now to FIGS. 10-12, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 10, illustrated is a methodology 1000 for supporting sleep mode operation for a radio coexistence manager (e.g., CxM 240) associated with a multi-radio wireless device (e.g., wireless device 110 or 200). It is to be appreciated that methodology 1000 can be performed by, for example, a wireless device and/or any other appropriate network device. Methodology 1000 can begin at block 1002, wherein one or more radios (e.g., radios 220) operating within at least one cluster (e.g., radio clusters 420) are identified. Next, at block 1004, operating states of respective identified radios are determined from among an active state, a sleep state, and a disabled state. Methodology 1000 can then conclude at block 1006, wherein a CxM operating mode is selected (e.g., from an active operating mode, a disabled operating mode, a wakeable sleep operating mode, or a non-wakeable sleep operating mode) based at least in part on the operating states of the radios respectively identified at block 1002 (e.g., as determined at block 1004).

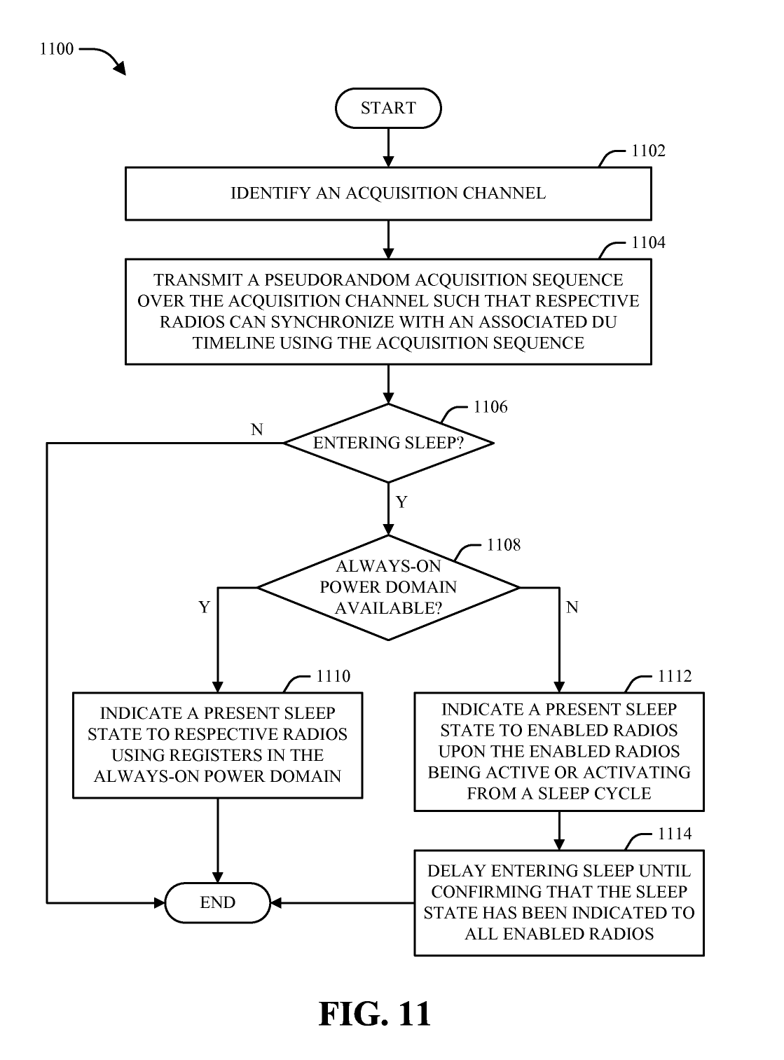

FIG. 11 illustrates another methodology 1100 for supporting CxM sleep mode operation. Methodology 1100 can be performed by, for example, a multi-radio wireless terminal and/or any other suitable network entity. Methodology 1100 begins at block 1102, wherein an acquisition channel is identified. Next, at block 1104, a pseudorandom acquisition sequence is transmitted over the acquisition channel identified at block 1102 such that respective radios can synchronize with an associated DU timeline using the acquisition sequence.

Methodology 1100 can then continue to block 1106, wherein it is determined whether a device performing methodology 1100 is entering sleep. If the device is not entering sleep, methodology 1100 can conclude. Otherwise, methodology 1100 can proceed to block 1108, wherein it is further determined whether an always-on power domain (e.g., an always-on power domain on an associated PMIC) is available. If such a power domain is available, methodology 1100 can conclude at block 1110, wherein a present sleep state (e.g., wakeable sleep or non-wakeable sleep) is indicated to respective radios using registers in the always-on power domain. Otherwise, methodology 1100 can proceed from block 1108 to block 1112, wherein a present sleep state is indicated to respective enabled radios upon the enabled radios being active or activating from a sleep cycle. Additionally, as shown at block 1114, a device performing methodology 1100 can conclude said methodology by delaying entering sleep until confirming that the sleep state has been indicated to substantially all enabled radios.

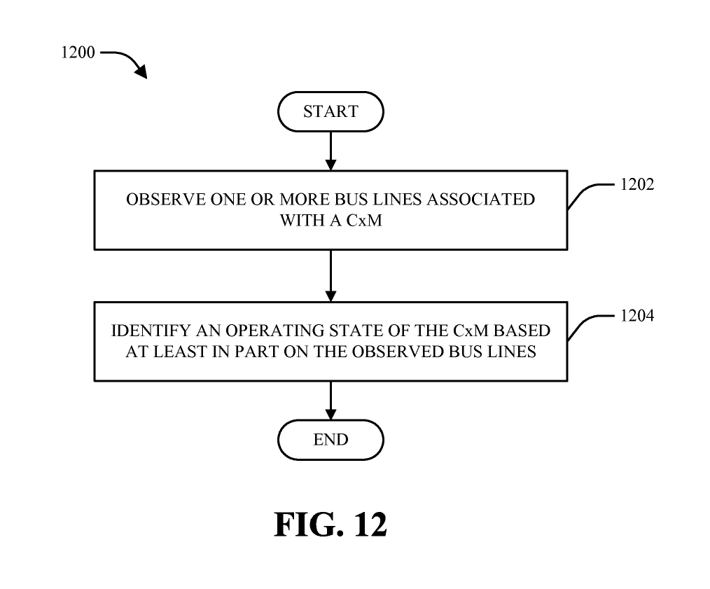

Referring next to FIG. 12, a methodology 1200 for ascertaining an operating state of an associated radio coexistence manager (e.g., CxM 240) is illustrated. Methodology 1200 can be performed by, for example, a radio device (e.g., wireless device 110 or 200, via respective radios 220) and/or any other suitable network device. Methodology 1200 can begin at block 1202, wherein one or more bus lines associated with a CxM (e.g., a clock line or a bus line, as illustrated by diagram 500) are observed. Methodology 1200 can then conclude at block 1204, wherein an operating state of the CxM is identified based at least in part on the bus line(s) observed at block 1202.

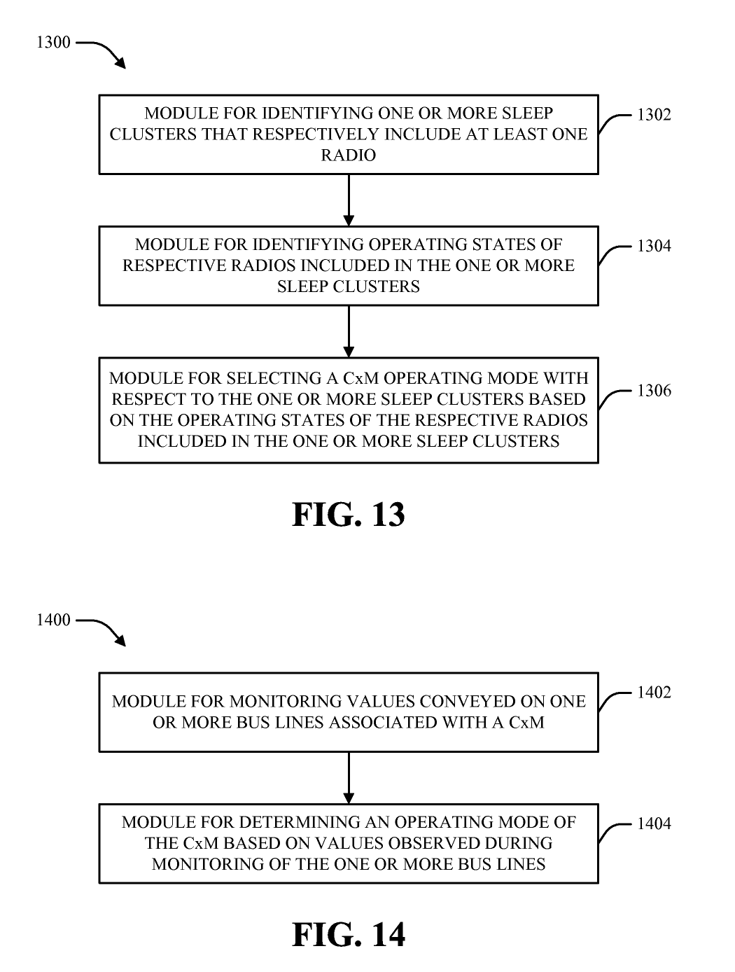

Referring next to FIG. 13-14, respective apparatuses 1300-1400 that can be utilized in accordance with various aspects described herein are illustrated. It is to be appreciated that apparatuses 1300-1400 are represented as including functional blocks, which can be functional blocks that represent functions implemented by a processor, software, or combination thereof (e.g., firmware).

With reference first to FIG. 13, an apparatus 1300 that facilitates usage of a sleep operating mode for a multi-radio coexistence manager is illustrated. Apparatus 1300 can be implemented by a wireless device (e.g., wireless device 110 or 200, via a CxM 240) and/or another suitable network entity and can include a module 1302 for identifying one or more sleep clusters that respectively include at least one radio, a module 1304 for identifying operating states of respective radios included in the one or more sleep clusters, and a module 1306 for selecting a CxM operating mode with respect to the one or more sleep clusters based on the operating states of the respective radios included in the one or more sleep clusters.

Turning next to FIG. 14, another apparatus 1400 that facilitates usage of a sleep operating mode for a multi-radio coexistence manager is illustrated. Apparatus 1400 can be implemented by a radio device (e.g., wireless device 110 or 200, via respective radios 220) and/or another suitable network entity and can include a module 1402 for monitoring values conveyed on one or more bus lines associated with a CxM and a module 1404 for determining an operating mode of the CxM based on values observed during monitoring of the one or more bus lines.

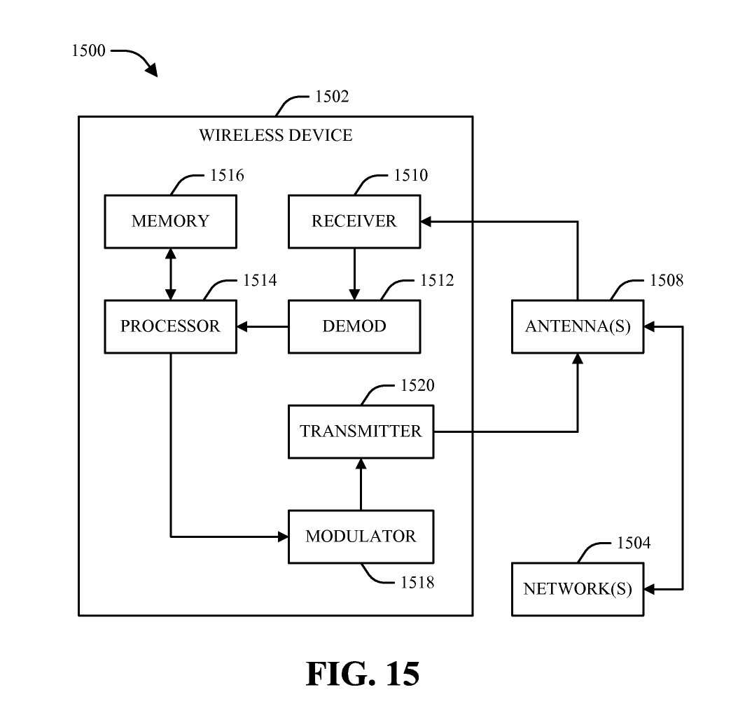

FIG. 15 is a block diagram of a system 1500 that can be utilized to implement various aspects of the functionality described herein. In one example, system 1500 includes a wireless device 1502. As illustrated, wireless device 1502 can receive signal(s) from one or more networks 1504 and transmit to the one or more networks 1504 via one or more antennas 1508. Additionally, wireless device 1502 can comprise a receiver 1510 that receives information from antenna(s) 1508. In one example, receiver 1510 can be operatively associated with a demodulator (Demod) 1512 that demodulates received information. Demodulated symbols can then be analyzed by a processor 1514. Processor 1514 can be coupled to memory 1516, which can store data and/or program codes related to terminal 1502. Additionally, wireless device 1502 can employ processor 1514 to perform methodologies 1000-1200 and/or other similar and appropriate methodologies. Wireless device 1502 can also include a modulator 1518 that can multiplex a signal for transmission by a transmitter 1520 through antenna(s) 1508.

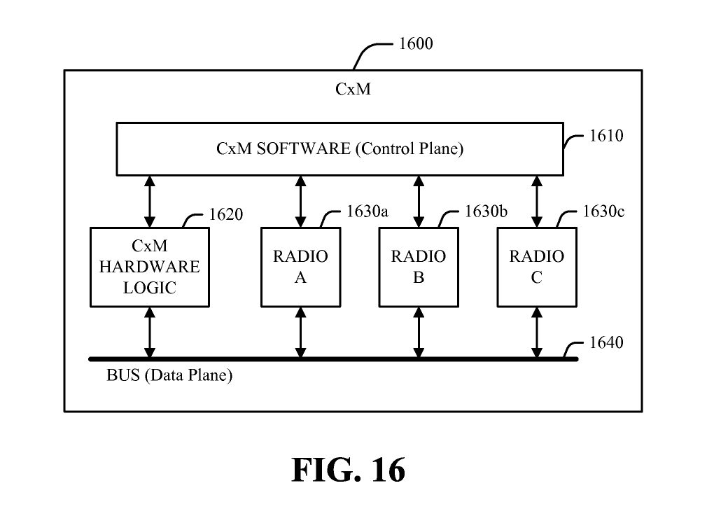

Turning next to FIG. 16, an example implementation of a CxM 1600 that can be utilized to implement various aspects described herein is illustrated. In one example, if multiple radios that can potentially interfere with each other are utilized in a wireless communication system, CxM 1600 can be used to coordinate the respective radios. In one example, CxM 1600 can be implemented as a mixture of software and hardware by utilizing, for example, control plane CxM software 1610 and CxM hardware logic 1620.

In accordance with one aspect, CxM 1600 can be implemented as a centralized architecture such that respective radios 1630a-1630c can coordinate and/or send notifications to CxM hardware logic 1620, which can in turn send notifications back to respective radios 1630a-1630c. In another example, operation of CxM 1600 can be split into hardware and software to accommodate time scales associated with coexistence issues. For example, radios 1630a-1630c can provide notifications of an imminent radio event at a substantially fast time scale (e.g., on the order of 100-150 microseconds), and accordingly CxM hardware logic 1620 and/or a data plane bus 1640 between CxM hardware logic 1620 and radios 1630a-1630c can be utilized to accommodate expedient operation based on notifications. Additionally or alternatively, CxM software 1610 can be implemented in the control plane to facilitate operations that can occur on a slower time scale, such as coordination radios coming on or off, sleep mode operation, or the like.

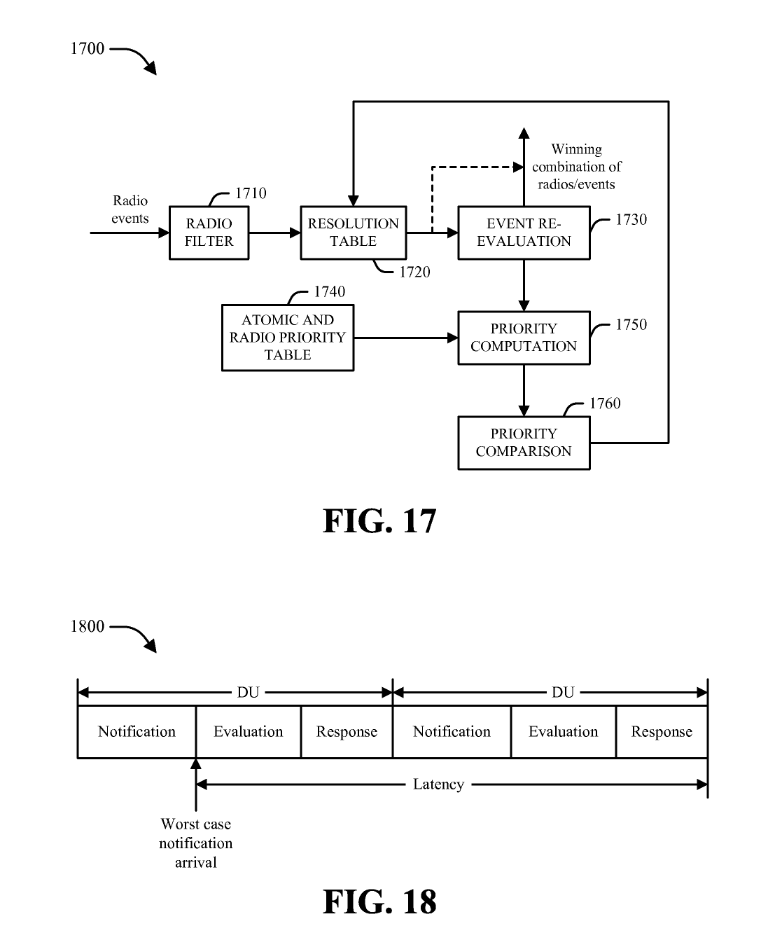

Diagram 1700 in FIG. 17 illustrates additional aspects of an example CxM implementation. As shown in diagram 1700, radio events can initially be processed by a radio filter 1710, which can identify groups or clusters of radios that can potentially interfere directly and/or indirectly. Next, a resolution table 1720 can be utilized to identify various parameters of the received events (e.g., transmit power, frequency subbands, receive power, tolerated interference, etc.) to determine whether the respective events can coexist.

Based on the operation of the resolution table 1720, an event re-evaluation block 1730 can then determine whether a highest priority (or “winning”) combination of radios and/or events exists. If such a combination does not exist, priority computation block 1750 can determine relative priorities associated with events and/or groups of events. In one example, priority computation block 1750 can leverage an atomic and radio priority table 1740, which can be implemented as a table per radio carrying priorities of atomic events and another table carrying relative priorities across radios. In an example, both of such tables can be configured by CxM software and can be static over a given CxM software update.

Based on priorities obtained by priority computation block 1750, arbitration can be performed for various combinations of events via priority comparison block 1760. In accordance with one aspect, priority comparison block 1760 can select the highest priority combination of events and provide such information to resolution table 1720 for re-evaluation.

Turning to diagram 1800 in FIG. 18, an example timeline for CxM operation is illustrated. In one example, a CxM can operate according to a timeline divided into decision units (DUs) in time, which can be any suitable uniform or non-uniform length (e.g., 100 μs). By way of specific example, a DU can be divided into a notification phase (e.g., 50 μs) where various radios send notifications of imminent events, an evaluation phase (e.g., 30 μs) where notifications are processed, and a response phase (e.g., 20 μs) where commands are provided to various radios and/or other operations are performed based on actions taken in the evaluation phase. In one example, timeline 1800 can have a latency parameter defined by the worst case operation of timeline 1800, e.g., the timing of a response in the case that a notification is obtained from a given radio immediately following termination of the notification phase in a given DU.

With respect to the above description, one of ordinary skill in the art can appreciate that various aspects described above can be implemented by hardware, software, firmware, middleware, microcode, or any combination thereof When the systems and/or methods are implemented in software, firmware, middleware or microcode, program code or code segments, they can be stored in a machine-readable medium, such as a memory or storage device. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

Moreover, those of skill in the art can appreciate that information and signals can be represented using any of a variety of different technologies and techniques. For example, data, instructions, commands, information, signals, bits, symbols, and/or chips that may be referenced throughout the above description can be represented by voltages, currents, electromagnetic waves, magnetic fields or particles, optical fields or particles, or any combination thereof.

In addition, it is to be understood that the steps of the various methods and/or algorithms as described in connection with the disclosure above can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium known in the art. An example storage medium can be coupled to a processor such that the processor can read information from, and write information to, the storage medium. In the alternative, the storage medium can be integral to the processor. The processor and the storage medium can reside in an ASIC, which in turn can reside in a user terminal and/or in any other suitable location. Alternatively, processor and the storage medium can reside as discrete components in a user terminal.

The above description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is instead to be accorded the widest scope consistent with the principles and novel features disclosed herein. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method, comprising:
identifying one or more radios operating within at least one cluster;
determining operating states of respective identified radios from among an active state, a sleep state, and a disabled state; and
selecting a coexistence manager (CxM) operating mode based at least in part on determined operating states of the respective identified radios.

2. The method of claim 1, wherein the selecting comprises selecting a disabled operating mode or a non-wakeable sleep operating mode upon determining that substantially all identified radios are in a disabled state.

3. The method of claim 1, wherein the selecting comprises selecting a non-wakeable sleep operating mode for a cluster upon determining that only one radio in the cluster is in an active or sleep state.

4. The method of claim 1, wherein the selecting comprises selecting an active operating mode upon determining that at least a first radio in a cluster is in an active state and at least a second radio in the cluster, disparate from the first radio, is in an active or sleep state.

5. The method of claim 1, wherein the selecting comprises selecting a wakeable sleep operating mode for a cluster upon determining that at least two radios in the cluster are not disabled and that substantially all radios in the cluster that are not disabled are in a sleep state.

6. The method of claim 1, further comprising transmitting an acquisition sequence, wherein the acquisition sequence is utilized by one or more radios to synchronize with an associated decision unit timeline.

7. The method of claim 6, wherein the transmitting comprises:
identifying an acquisition channel;
constructing the acquisition sequence as a pseudorandom sequence; and
transmitting the acquisition sequence on the acquisition channel.

8. The method of claim 7, wherein:
the identifying an acquisition channel comprises identifying a set of 64-bit radio access channels starting with a header of ‘00’ and ending with a trailer of ‘11’ and identifying the acquisition channel as an additional 64-bit broadcast channel; and
the constructing comprises constructing the acquisition sequence as a 64-bit pseudorandom sequence.

9. The method of claim 1, further comprising indicating the CxM operating mode to respective identified radios.

10. The method of claim 9, wherein the indicating comprises setting registers associated with the respective identified radios.

11. The method of claim 10, wherein the setting comprises setting the registers associated with the respective identified radios on an always-on power domain.

12. The method of claim 10, wherein:
the registers are on an always-on power domain in an associated power management integrated circuit (PMIC); and
the selecting further comprises selecting an active operating mode upon receiving a wake-up command from the PMIC, the wake-up command provided by the PMIC in response to an identified radio interrupting the PMIC and based on an operating mode stored in a register associated with the identified radio.

13. The method of claim 9, wherein:
the selecting comprises selecting a sleep operating mode;
the indicating comprises indicating the sleep operating mode to respective enabled radios upon identifying respective enabled radios operating in an active state or respective enabled radios operating in a sleep state that are activated pursuant to an associated sleep cycle; and
the method further comprises entering the sleep operating mode upon confirming that the sleep operating mode has been indicated to substantially all enabled radios.

14. The method of claim 9, wherein the indicating comprises pulling a bus line low to indicate sleep operation.

15. The method of claim 14, wherein the bus line is a clock line.

16. A wireless communications apparatus, comprising:
a memory that stores data relating to one or more radios and at least one radio cluster in which the one or more radios operate; and
a processor configured to determine operating states of the one or more radios from among an active state, a sleep state, and a disabled state, and to select a coexistence manager (CxM) operating mode based at least in part on determined operating states of the one or more radios.

17. The wireless communications apparatus of claim 16, wherein the processor is further configured to select a disabled CxM operating mode or a non-wakeable sleep CxM operating mode upon determining that substantially all of the one or more radios are in a disabled state.

18. The wireless communications apparatus of claim 16, wherein the processor is further configured to select a non-wakeable sleep CxM operating mode for a radio cluster upon determining that only one radio in the radio cluster is in an active or sleep state.

19. The wireless communications apparatus of claim 16, wherein the processor is further configured to select an active CxM operating mode upon determining that at least a first radio in a radio cluster is in an active state and at least a second radio in the radio cluster, disparate from the first radio, is in an active or sleep state.

20. The wireless communications apparatus of claim 16, wherein the processor is further configured to select a wakeable sleep CxM operating mode for a radio cluster upon determining that at least two radios in the radio cluster are not disabled and that substantially all non-disabled radios in the radio cluster are in a sleep state.

21. The wireless communications apparatus of claim 16, wherein the processor is further configured to transmit an acquisition sequence usable by the one or more radios to synchronize with a decision unit timeline associated with the wireless communications apparatus.

22. The wireless communications apparatus of claim 21, wherein:
the memory further stores data relating to an acquisition channel; and
the processor is further configured to construct the acquisition sequence as a pseudorandom sequence and to transmit the acquisition sequence on the acquisition channel.

23. The wireless communications apparatus of claim 22, wherein:
the memory further stores data relating to a set of 64-bit radio access channels starting with a header of ‘00’ and ending with a trailer of ‘11’; and
the processor is further configured to identify the acquisition channel as an additional 64-bit broadcast channel and to construct the acquisition sequence as a 64-bit pseudorandom sequence.

24. The wireless communications apparatus of claim 16, wherein the processor is further configured to indicate the CxM operating mode to respective radios.

25. The wireless communications apparatus of claim 24, wherein the processor is further configured to indicate the CxM operating mode to respective radios by setting registers associated with the respective radios.

26. The wireless communications apparatus of claim 25, wherein the processor is further configured to set registers associated with the respective radios on an always-on power domain.

27. The wireless communications apparatus of claim 25, wherein:
the memory further stores data relating to an always-on power domain in an associated power management integrated circuit (PMIC) that comprises the registers; and
the processor is further configured to select an active CxM operating mode upon receiving a wake-up command from the PMIC, the wake-up command provided by the PMIC in response to a radio interrupting the PMIC and based on a CxM operating mode stored in a register associated with the radio.

28. The wireless communications apparatus of claim 25, wherein the processor is further configured to select a sleep CxM operating mode, to indicate the sleep CxM operating mode to respective enabled radios upon identifying respective enabled radios operating in an active state or respective enabled radios operating in a sleep state that are activated pursuant to an associated sleep cycle, and to facilitate entry into the sleep CxM operating mode upon confirming that the sleep CxM operating mode has been indicated to substantially all enabled radios.

29. The wireless communications apparatus of claim 25, wherein the processor is further configured to pull one or more bus lines low to indicate a sleep CxM operating mode.

30. The wireless communications apparatus of claim 29, wherein the one or more bus lines comprise a clock line.

31. An apparatus, comprising:
means for identifying one or more sleep clusters that respectively include at least one radio;
means for identifying operating states of respective radios included in the one or more sleep clusters; and
means for selecting a coexistence manager (CxM) operating mode with respect to the one or more sleep clusters based on the operating states of the respective radios included in the one or more sleep clusters.

32. The apparatus of claim 31, wherein the means for selecting comprises means for selecting a disabled operating mode or a non-wakeable sleep operating mode upon determining that substantially all identified radios are in a disabled state.

33. The apparatus of claim 31, wherein the means for selecting comprises means for selecting a non-wakeable sleep operating mode for a sleep cluster upon determining that only one radio in the sleep cluster is in an active or sleep state.

34. The apparatus of claim 31, wherein the means for selecting comprises means for selecting an active operating mode upon determining that at least a first radio in a sleep cluster is in an active state and at least a second radio in the sleep cluster, disparate from the first radio, is in an active or sleep state.

35. The apparatus of claim 31, wherein the means for selecting comprises means for selecting a wakeable sleep operating mode for a sleep cluster upon determining that at least two radios in the sleep cluster are not disabled and that substantially all radios in the sleep cluster that are not disabled are in a sleep state.

36. The apparatus of claim 31, further comprising means for transmitting an acquisition sequence, wherein the acquisition sequence is utilized by one or more radios to synchronize with a decision unit timeline associated with the apparatus.

37. The apparatus of claim 36, wherein the means for transmitting comprises:
means for identifying an acquisition channel;
means for constructing the acquisition sequence as a pseudorandom sequence; and
means for transmitting the acquisition sequence on the acquisition channel.

38. The apparatus of claim 37, wherein:
the means for identifying an acquisition channel comprises means for identifying a 64-bit broadcast channel as the acquisition channel; and
the means for constructing comprises means for constructing the acquisition sequence as a 64-bit pseudorandom sequence.

39. The apparatus of claim 31, further comprising means for indicating the CxM operating mode to the respective radios included in the one or more sleep clusters.

40. The apparatus of claim 39, wherein the means for indicating comprises means for setting registers associated with the respective radios included in the one or more sleep clusters.

41. The apparatus of claim 40, wherein the registers are on an always-on power domain.

42. The apparatus of claim 41, wherein:
the always-on power domain is associated with a power management integrated circuit (PMIC); and
the means for selecting further comprises means for receiving a wake-up command from the PMIC, the wake-up command provided in response to an identified radio interrupting the PMIC and based on an operating mode stored in a register associated with the identified radio, and means for selecting an active operating mode upon receiving the wake-up command.

43. The apparatus of claim 39, wherein:
the means for selecting comprises means for selecting a sleep operating mode;
the means for indicating comprises means for indicating the sleep operating mode to respective enabled radios upon identifying respective enabled radios operating in an active state or respective enabled radios operating in a sleep state that are activated pursuant to an associated sleep cycle; and
the apparatus further comprises means for delaying entry into the sleep operating mode until confirming that the sleep operating mode has been indicated to substantially all enabled radios.

44. The apparatus of claim 39, wherein the means for indicating comprises means for pulling one or more bus lines low to indicate sleep operation.

45. The apparatus of claim 44, wherein the one or more bus lines comprise a clock line.

46. A computer program product, comprising:
a computer-readable medium, comprising:
code for causing a computer to identify one or more radios and at least one radio cluster in which the one or more radios operate;
code for causing a computer to determine operating states of the one or more radios from among an active state, a sleep state, and a disabled state; and
code for causing a computer to select a coexistence manager (CxM) operating mode based at least in part on determined operating states of the one or more radios.

47. An integrated circuit that executes a set of machine-executable instructions, the set of machine-executable instructions comprising:
identifying one or more sleep clusters that respectively include at least one radio;
identifying operating states of respective radios included in the one or more sleep clusters; and
selecting a coexistence manager (CxM) operating mode with respect to the one or more sleep clusters based on the operating states of the respective radios included in the one or more sleep clusters.

48. A method, comprising:
observing one or more bus lines associated with a coexistence manager (CxM); and
identifying an operating state of the CxM based at least in part on the observing.

49. The method of claim 48, wherein the identifying comprises determining that the CxM is in a sleep state upon observing that one or more bus lines associated with the CxM are pulled low.

50. The method of claim 49, wherein the identifying comprises determining that the CxM is in a sleep state upon observing that a clock line associated with the CxM is pulled low.

51. The method of claim 48, wherein the identifying comprises identifying an operating state of the CxM upon activating from a sleep operating state.

52. The method of claim 51, further comprising:
identifying a sleep sub-state utilized by the CxM for an associated radio cluster from a set of sleep sub-states comprising wakeable sleep and non-wakeable sleep upon identifying a sleep operating state as the operating state of the CxM; and
waking the CxM upon identifying that the sleep sub-state utilized by the CxM is wakeable sleep.

53. The method of claim 48, wherein:
the identifying comprises identifying an operating state of the CxM upon becoming enabled from a disabled operating state; and
the method further comprises waking the CxM upon identifying a sleep operating state as the operating state of the CxM.

54. A wireless communications apparatus, comprising:
a memory that stores data relating to a coexistence manager (CxM) and a bus associated with the CxM comprising at least one bus line; and
a processor configured to determine an operating mode utilized by the CxM at least in part by monitoring the bus associated with the CxM.

55. The wireless communications apparatus of claim 54, wherein the processor is further configured to identify that a sleep operating mode is being utilized by the CxM upon observing that one or more bus lines of the bus associated with the CxM are pulled low.

56. The wireless communications apparatus of claim 54, wherein the at least one bus line comprises a clock bus line and the processor is further configured to identify that a sleep operating mode is being utilized by the CxM upon observing that the clock bus line is pulled low.

57. The wireless communications apparatus of claim 54, wherein the processor is further configured to determine the operating mode utilized by the CxM upon activating from a sleep operating state.

58. The wireless communications apparatus of claim 57, wherein the processor is further configured to identify a sleep state utilized by the CxM for a radio cluster associated with the wireless communications apparatus upon determining that the operating mode utilized by the CxM is a sleep operating mode, the sleep state selected from the group consisting of wakeable sleep and non-wakeable sleep, and to wake the CxM upon identifying wakeable sleep as the sleep state utilized by the CxM.

59. The wireless communications apparatus of claim 54, wherein the processor is further configured to determine the operating mode utilized by the CxM upon becoming enabled from a disabled operating state and to wake the CxM upon determining that the operating mode utilized by the CxM is a sleep operating mode.

60. An apparatus, comprising:
means for monitoring values conveyed on one or more bus lines associated with a coexistence manager (CxM); and
means for determining an operating mode of the CxM based on values observed during monitoring of the one or more bus lines.

61. The apparatus of claim 60, wherein the means for determining comprises means for determining that the CxM is in a sleep mode upon observing that one or more bus lines associated with the CxM are pulled low.

62. The apparatus of claim 61, wherein:
the one or more bus lines associated with the CxM comprise a clock line; and
the means for determining comprises means for determining that the CxM is in a sleep mode upon observing that the clock line is pulled low.

63. The apparatus of claim 60, wherein the means for determining comprises means for determining an operating mode of the CxM upon activating from sleep.

64. The apparatus of claim 63, further comprising:
means for identifying a sleep state utilized by the CxM for a radio cluster associated with the apparatus from a set of sleep states comprising wakeable sleep and non-wakeable sleep upon determining that the operating mode of the CxM is a sleep mode; and
means for waking the CxM upon identifying wakeable sleep as the sleep state utilized by the CxM.

65. The apparatus of claim 60, wherein:
the means for determining comprises means for determining an operating mode of the CxM upon becoming enabled; and
the apparatus further comprises means for waking the CxM upon determining that the operating mode utilized by the CxM is a sleep mode.

66. A computer program product, comprising:
a computer-readable medium, comprising:
code for causing a computer to identify a coexistence manager (CxM);
code for causing a computer to identify a bus associated with the CxM; and
code for causing a computer to determine an operating mode utilized by the CxM at least in part by monitoring the bus associated with the CxM.

67. An integrated circuit that executes a set of machine-executable instructions, the set of machine-executable instructions comprising:
monitoring values conveyed on one or more bus lines associated with a coexistence manager (CxM); and
determining an operating mode of the CxM based on values observed during monitoring of the one or more bus lines.
